(19) United States
(12) Patent Application Publication
(10) Pub. No.: US 2025/0167940 A1
(43) Pub. Date: May 22, 2025

(54) METHODS AND APPARATUS FOR SPATIAL DOMAIN MULTIPLEXING OF SENSING SIGNAL AND COMMUNICATION SIGNAL

(71) Applicant: Huawei Technologies Co., Ltd., Shenzhen (CN)

(72) Inventors: Alireza Bayesteh, Brossard (CA); Jianglei Ma, Ottawa (CA); Wen Tong, Ottawa (CA); Peiying Zhu, Kanata (CA)

(21) Appl. No.: 18/925,484

(22) Filed: Oct. 24, 2024

Related U.S. Application Data
(63) Continuation of application No. PCT/CN2022/088824, filed on Apr. 24, 2022.

(51) Int. Cl. H04L 5/00

(52) U.S. Cl. CPC H04L 5/0023; H04L 5/0048

(57) ABSTRACT

Some embodiments of the present disclosure provide for multiplexing sensing signals and communication signals in a spatial domain, a frequency domain and a time domain. In some instances, a sensing signal may be used for communication. Signals of three types are considered: communication-only; sensing-only; and joint sensing and communication. The types of signals may be distinguished by their waveform and/or numerology configurations. Spatial domain multiplexing may be enabled by establishing an association between a three-dimensional resource block and a signal configuration. The three-dimensional resource block may be defined using a spatial domain element, a frequency domain element and a time domain element.

### CROSS-REFERENCE TO RELATED APPLICATIONS

This application is a continuation of International Application No. PCT/CN2022/088824, filed on Apr. 24, 2022, the disclosure of which is hereby incorporated by reference in its entirety.

### TECHNICAL FIELD

The present disclosure relates, generally, to multiplexing of sensing signals and communication signals and, in particular embodiments, to carrying out such multiplexing in a spatial domain.

### BACKGROUND

User Equipment (UE) position information can be used in cellular communication networks to improve various performance metrics for the network. Such performance metrics may, for example, include capacity, reliability, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information. UE pose information may include a location of the UE in a global coordinate system, a velocity vector for the UE, including a speed and a direction of movement in the global coordinate system, orientation information and information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from a communication system, it is known to be advantageous to gather information using a system that integrates a sensing system and a communication system into an integrated system. An integrated system may be shown to lead to a reduction in an amount of hardware and, consequently, cost for the system. An integrated system may also be shown to lead to a reduction in the time resources, frequency resources and spatial resources used to perform the sensing function and the communications function.

### SUMMARY

Aspects of the present application relate to multiplexing sensing signals and communication signals in a spatial domain, a frequency domain and a time domain. In some instances, a sensing signal may be used for communication. Signals of three types are considered: communication-only; sensing-only; and joint sensing and communication. The types of signals may be distinguished by their waveform and/or waveform parameters. Waveform parameters include numerology configurations. Aspects of the present application relate to enabling spatial domain multiplexing by establishing an association between a resource block and a signal configuration. The resource block may be defined using a spatial domain element.

It is known to treat sensing and communication functionalities separately, i.e., a signal is either designed for sensing or the signal is designed for communication. Such separate treatment may be shown to lead to efficiency loss.

Conveniently, aspects of the present application provide spatial domain multiplexing of communication and sensing signals from a radio access network (system-level) design perspective.

Aspects of the present application relate to an efficient integrated sensing and communication network, wherein a communication signal may be reused for sensing and vice versa.

By defining three-dimensional configurations of joint sensing and communication resource hopping patterns over time domain, frequency domain and spatial domain, a reduction in interference between different nodes and between sensing and communication signals transmitted by the same node may be achieved.

Efficient multiplexing of sensing and communication signals over the spatial domain may be shown to benefit both the sensing application and the communication application on the basis of the spatial domain degrees of freedom.

According to an aspect of the present disclosure, there is provided a method of facilitating spatial multiplexing of different types of signals. The method includes establishing an association between a first resource block and a first type of signal, the first resource block defined using a first spatial domain element, establishing an association between a second resource block and a second type of signal, the second resource block defined using a second spatial domain element, transmitting the first type of signal in the first resource block and transmitting the second type of signal in the second resource block.

According to another aspect of the present disclosure, there is provided a method of facilitating spatial multiplexing of different types of signals. The method includes obtaining an association between a first resource block and a first type of signal, the first resource block defined using a first spatial domain element, obtaining an association between a second resource block and a second type of signal, the second resource block defined using a second spatial domain element, receiving the first type of signal in the first resource block and receiving the second type of signal in the second resource block.

According to another aspect of the present disclosure, there is provided an apparatus comprising a processor configured to perform a method of any of the disclosed embodiments or aspects.

According to another aspect of the present disclosure, there is provided a computer-readable storage medium comprising instructions which, when executed by a computer, cause the computer to carry out a method of any of the disclosed embodiments or aspects.

Optionally, in an embodiment, the first type of signal comprises a communication-only signal. In a further embodiment, the second type of signal comprises a joint sensing and communication signal. In another further embodiment, the second type of signal comprises a sensing-only signal.

Optionally, in an embodiment, the first spatial domain element comprises a beam. In an embodiment, the method further comprises generating the beam using analog beamforming. In an embodiment, the method further comprises generating the beam using hybrid analog-digital beamforming.

Optionally, in an embodiment, the first spatial domain element comprises a multiple input multiple (MIMO) output layer. In an embodiment, the method further comprises generating the MIMO output layer using digital precoding.

Optionally, in an embodiment, the first spatial domain element comprises a polarization.

Optionally, in an embodiment, the method further comprises associating the first spatial domain element of the first three-dimensional resource block with a first spatial domain index, among a plurality of spatial domain indices. In an embodiment, the first spatial domain index corresponds to a first codeword in a pre-configured codebook.

Optionally, in an embodiment, the method further comprises associating a particular waveform and numerology with the first type of signal, wherein the transmitting the first type of signal includes transmitting using the particular waveform and numerology.

Optionally, in an embodiment, the method further comprises defining a reference signal pattern; and associating the reference signal pattern with the first type of signal; wherein the transmitting the first type of signal includes transmitting the reference signal pattern.

Optionally, in an embodiment, the method further comprises associating a value of an indicator with the first type of signal; and transmitting, to a terminal, an association of the value of the indicator with the first spatial domain element. In an embodiment, the value of the indicator comprises one of two values. In an embodiment, the value of the indicator comprises one of four values.

Optionally, in an embodiment, the first three-dimensional resource block and the second three-dimensional resource block are part of a given resource set. In an embodiment, the method further comprises selecting, from a resource set pool including a plurality of resource sets, the given resource set. In an embodiment, the selecting comprises selecting randomly. In an embodiment, the selecting comprises selecting according to a pre-configured mapping function.

Optionally, in an embodiment, the first resource block comprises a first three-dimensional resource block using a first frequency domain element and a first time domain element. In an embodiment, the second resource block comprises a second three-dimensional resource block using a second frequency domain element and a second time domain element.

Optionally, in an embodiment, the association between the first resource block the first type of signal comprises an explicit association.

Optionally, in an embodiment, the association between the first resource block the first type of signal comprises an implicit association.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6A illustrates a terrestrial transmit receive point and a plurality of radiation patterns corresponding to analog beamforming;

FIG. 6B illustrates a terrestrial transmit receive point and a plurality of radiation patterns corresponding to digital beamforming;

FIG. 7 illustrates a table of values for a two-bit indicator and corresponding indications, in accordance with aspects of the present application;

FIG. 8 illustrates a three-dimensional region defined by a time axis, a frequency axis and a space axis, within the region is a first resource set including individual three-dimensional resource blocks configured for communication only, for joint communication and sensing or neither for communication nor for sensing, in accordance with aspects of the present application;

FIG. 9 illustrates a three-dimensional region defined by a time axis, a frequency axis and a space axis, within the region is a second resource set including individual three-dimensional resource blocks configured for communication only, for joint communication and sensing or neither for communication nor for sensing, in accordance with aspects of the present application;

FIG. 10 illustrates a three-dimensional region defined by a time axis, a frequency axis and a space axis, within the region is a second resource set including individual three-dimensional resource blocks configured for communication-only, for sensing-only, for joint communication and sensing or neither for communication, nor for sensing, in accordance with aspects of the present application;

FIG. 11 illustrates a three-dimensional hopping pattern generator, in accordance with aspects of the present application;

FIG. 12A illustrates a terrestrial transmit receive point and a plurality of coarse radiation patterns corresponding to analog beamforming; and

FIG. 12B illustrates a terrestrial transmit receive point and a plurality of fine radiation patterns corresponding to digital beamforming; and

FIG. 13 illustrates a beam-time-frequency pattern associated with a sensing cycle, in accordance with aspects of the present application.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

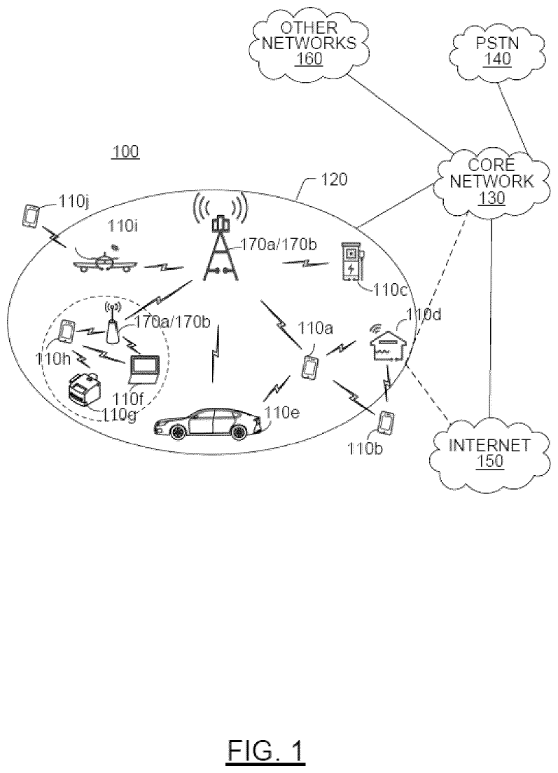

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

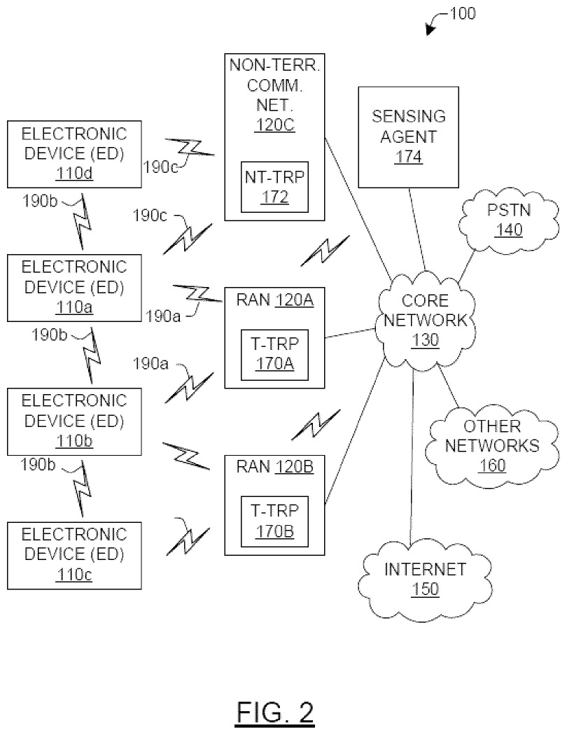

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over an non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Discrete Fourier Transform spread OFDMA (DFT-s-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

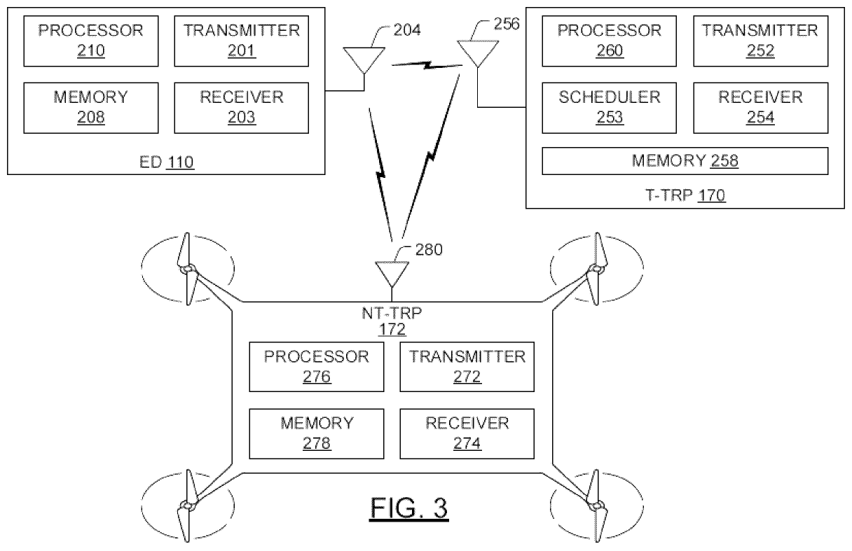

FIG. 3 illustrates another example of an ED 110 and a base station 170a, 170b and/or 170c. The ED 110 is used to connect persons, objects, machines, etc. The ED no may be widely used in various scenarios, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED no represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. A panel is a unit of an antenna group, or antenna array, or antenna sub-array, which unit can control a Tx beam or a Rx beam independently. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260, in addition to the operations described hereinbefore, may perform other network-side processing operations described hereinafter, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may, alternatively, be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

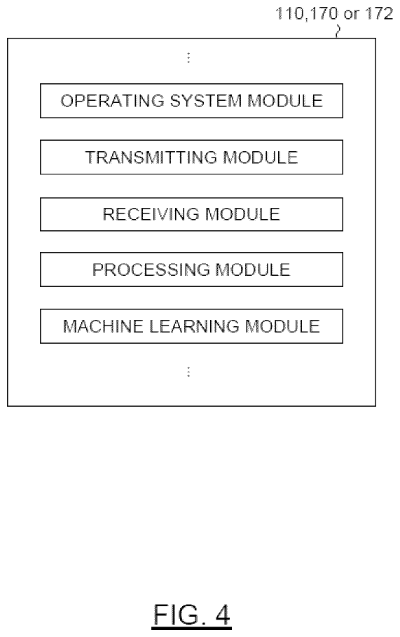

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Discrete Fourier Transform spread OFDM (DFT-s-OFDM), Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; OFDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler shift); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0-5%.

The carrier, the BWP or the occupied bandwidth may be signaled by a network device (e.g., by a base station 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

UE position information may be used in cellular communication networks to improve various performance metrics for the network. Such performance metrics may, for example, include capacity, reliability, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. In some cases, a plurality of sensing agents 174 may be implemented and may communicate with each other to jointly perform a sensing task. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a node that implements a sensing management function (SMF). In some networks, the SMF may also be known as a node that implements a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260. In this scenario, the sensing node may provide the sensing information to the SMF for processing.

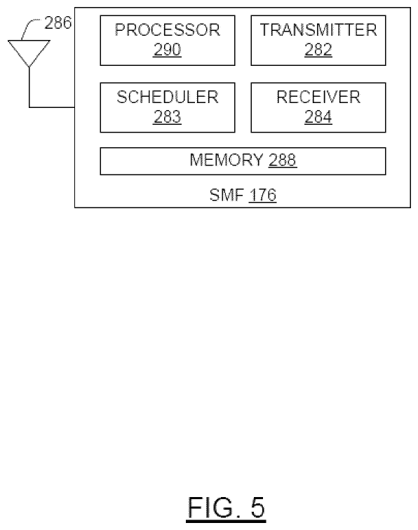

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit, receive, or process (or any combination) a signal specific to pose determination process. Positioning techniques based on a global navigation satellite system (GNSS) such as the known Global Positioning System (GPS) are other examples of the active pose estimation paradigm. Various positioning technologies are also known in NR systems and in LTE systems.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectra for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase “Radio Detection and Ranging”; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}), where α=f_{chirp1}−f_{chirp0}/t_{chirp1}−t_{chirp0} is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπαt}^{²} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP 172 may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A beam may be formed by performing amplitude and/or phase weighting on data transmitted or received by at least one antenna port. A beam may be constructed in analog (RF) domain by phase shifters, in digital domain (baseband) through precoding or in a hybrid analog/digital domain. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a SSB resource identifier, or a sounding reference signal (SRS) resource identifier, or other reference signal resource identifier.

If a wireless network operator offers sensing and communications as two vertical services in an integrated framework, the sensing and communications vertical services may be expected to share the spatial domain in an efficient way so that both services can benefit from the integrated framework. Traditional solutions treat communication and sensing as two separate entities, where each entity has respective key performance indicators and design criteria. However, for an efficient integrated solution, it can be shown that considering the two functionalities as a whole may allow for optimizing the wireless network for simultaneous, or near-simultaneous, communication and sensing.

Spatial domain multiplexing of communication signals is well established and well understood. Specific examples of spatial domain multiplexing of communication signals include multiplexing in the polarization domain (e.g., one signal transmitted over horizontal polarization and another signal transmitted over vertical polarization), multiplexing in the beam domain using analog beamforming (e.g., in massive MIMO, “m-MIMO”) and multiplexing in the MIMO layer domain through digital precoding (e.g., in downlink multi-user MIMO, “DL MU-MIMO”).

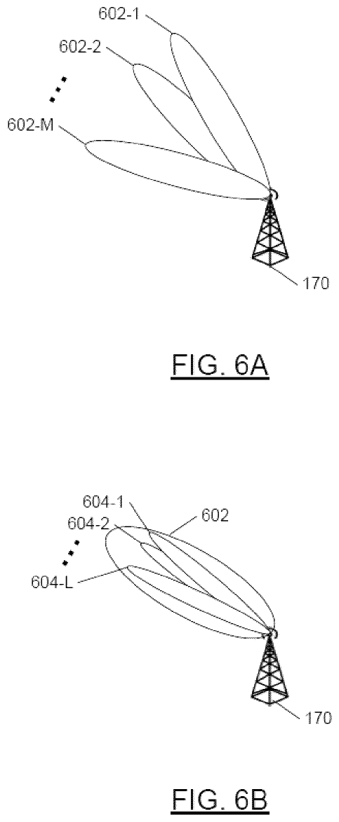

In analog beamforming, the T-TRP 170 may adjust, in the RF domain, signal phases of individual signals transmitted at each antenna of the antenna array 256. Analog beamforming may be shown to impact a radiation pattern and a gain of the antenna array 256. The antenna gain provided through the use of analog beamforming may be shown to partly overcome the known impact of high pathloss in mmWave transmissions. FIG. 6A illustrates a T-TRP 170 and a plurality of radiation patterns corresponding to analog beamforming. The radiation patterns are labelled with reference numbers 602-1, 602-2, . . . , 602-M. The suffix for each radiation pattern reference number may be considered to be an analog beamforming index, which may be referenced hereinafter as i₁. The analog beamforming index, i₁, may take on values from 1 to M, inclusive.

In digital beamforming, the T-TRP 170 may pre-code, with amplitude and phase modifications in baseband processing, a to-be-transmitted signal before RF transmission. The T-TRP 170 may simultaneously form multiple beams (say, for example, one beam per receiver, UE 110) from the same set of antenna elements 256. Digital beamforming may be shown to improve the capacity of the cell defined as being served by the T-TRP 170. The improved capacity may be understood to come about due to the same resources being used to transmit data simultaneously to multiple UEs 110. FIG. 6B illustrates a T-TRP 170 and a plurality of radiation patterns corresponding to digital beamforming. The radiation patterns are labelled with reference numbers 604-1, 604-2, . . . , 604-L. Notably, the digital beamforming radiation patterns 604 are illustrated within a single generic analog beamforming radiation pattern 602. The suffix for each digital beamforming radiation pattern reference number may be considered to be a digital beamforming index, which may be referenced hereinafter as i₂. The digital beamforming index, i₂, may take on values from 1 to L, inclusive.

In the context of dual polarization, there are, clearly, only two choices. However, for consistency with the analog beamforming index, i₁, and the digital beamforming index, i₂, a polarization index may be referenced hereinafter as i₃. The polarization index, i₃, may take on the value 1 or 2.

Spatial domain multiplexing of sensing signals and communication signals may be considered to have received much less attention and research in comparison to other multiplexing schemes. The few known spatial domain multiplexing solutions may be considered to only aim to minimize mutual interference between the sensing signals and the communication signals.

Aspects of the present application relate to multiplexing sensing signals and communication signals in a spatial domain, a frequency domain and a time domain. In some instances, a sensing signal may be used for communication. Three types of signals are considered. The three types of signals may be distinguished by their configurations. That is, the three types of signals may be configured to use distinct waveforms and/or numerologies.

A first type of signal may be optimized for communications only. A second type of signal may be optimized for sensing-only. A third type of signal may be used for joint sensing and communication (JSAC), which may also be known as integrated sensing and communication (ISAC), and may be optimized to achieve a suitable trade-off between sensing and communications. For the multiplexing (across the spatial domain, the frequency domain and the time domain) representative of aspects of the present application, many scenarios are contemplated herein. The scenarios relate to the implementation of the spatial domain and include: a beam domain (analog beamforming) scenario; a MIMO layer domain (digital beamforming) scenario; a polarization domain scenario; a scenario that combines two of these scenarios; and a scenario that combines all three of these scenarios.

In overview, aspects of the present application relate to enabling spatial domain multiplexing by establishing an association between a three-dimensional resource block and a signal configuration (communication-only, sensing-only, or JSAC). The three-dimensional resource block may be defined using a spatial domain element (e.g., a beam or a MIMO layer or a polarization indication), a frequency domain element (e.g., a bandwidth part) and a time domain element (e.g., a symbol block).

The spatial domain multiplexing may be performed such that three-dimensional resource blocks are configured in a manner that is specific to the type of the signal. The spatial domain multiplexing may, additionally or alternatively, be performed such that each three-dimensional resource block may be associated with the type of the signal. The type of signal may be a type that is optimized for communication-only, a type that is optimized for sensing-only, or a type that is optimized for JSAC.

By configuring, at a transmitting entity (e.g., a T-TRP 170), a signal in a three-dimensional resource block in a manner that is specific to a type of the signal, a receiving entity (e.g., a UE 110) may have an initial indication with respect to the manner in which the received spatial domain element may be processed. Similarly, by associating, at a transmitting entity (e.g., a T-TRP 170), a three-dimensional resource block with a type of the signal, a receiving entity (e.g., a UE 110) may have an initial indication with respect to the manner in which the received signal may be processed.

A receiving entity, upon receiving a signal in a three-dimensional resource block associated with communication-only, may limit processing of the signal to decoding data and transmitting feedback that indicates an acknowledgement, “ACK,” or a negative acknowledgment, “NACK.” A receiving entity, upon receiving a signal in a three-dimensional resource block associated with sensing-only, may process the signal to perform sensing measurements and feedback sensing results to the network. A receiving entity, upon receiving a signal in a three-dimensional resource block associated with JSAC, may process the signal to decode data, perform sensing measurements and transmit feedback.

In general, each spatial domain element, used to define one dimension of a three-dimensional resource block, may be understood to correspond to a weighting vector, w, applied on specific antenna ports of the physical transmit antennas 256. The application of the weighting vector, w, may be shown to allow for analog beamforming, digital beamforming (MIMO layer), hybrid analog-digital beamforming or polarization (by doubling the antenna space).

A particular configuration of spatial domain multiplexing may be specified using a combination of the analog beamforming index, i₁, the digital beamforming index, i₂, and the polarization index, i₃. The combination, (i₁, i₂, i₃), of the three indices may be called a spatial domain index.

Unlike traditional resource elements in the time/frequency domain, each spatial domain element in the spatial domain may be considered to occupy a continuous domain. The continuous nature of the spatial domain allows for spatial domain elements to have partial overlap. A spatial domain index for configuring transmission from a particular TRP 170 may only include a subset of indices or the entire set of indices. For example, a particular spatial domain index may only include the digital beamforming index, i₂. In some aspects of the present application, each spatial domain index, among a plurality of spatial domain indices, corresponds to a codeword in a pre-configured codebook/dictionary. This scenario may be familiar in the context of so-called precoding codebooks.

From the perspective of the UE 110, the association between a received signal in a three-dimensional resource block and a type of signal (communication-only, sensing-only or JSAC) may be implicit or explicit.

An implicit association may be determined, by the UE 110, by recognizing that a received signal in a three-dimensional resource block has a particular waveform and a particular waveform parameter. One example waveform parameter is known as a numerology. The UE 110 may be preconfigured to have an association between the particular waveform and parameter/numerology and a particular type of signal (communication-only, sensing-only or JSAC). In some embodiments, the UE 110 can acquire the association through higher layer signaling (e.g., RRC and MAC-CE) during the initial access.

An implicit association may be communicated by defining a plurality of reference signal patterns and associating one or more reference signal patterns with the communication-only type of signal, associating one or more other reference signal patterns with the sensing-only type of signal and associating one or more further reference signal patterns with the JSAC type of signal.

An implicit association may be communicated by defining a plurality of three dimensional (3D) hopping patterns (in time, frequency and space), associating elements of the one or more 3D hopping patterns with the sensing-only type of signal and associating elements of the one or more 3D hopping patterns with the communication-only type of signal and associating elements of the one or more 3D hopping patterns with the JSAC type of signal.

An explicit association between a given three-dimensional resource block and type of signal may be communicated by transmitting, as part of the signal in the three-dimensional resource block, a binary indicator, ISAC_indicator. Each terminal may have a record of an explicit association between an ISAC_indicator and a particular set of parameters (e.g., waveform, waveform parameter/numerology) for potential received signals. In addition, this binary indicator may differ for distinct Carrier/BWP configurations.

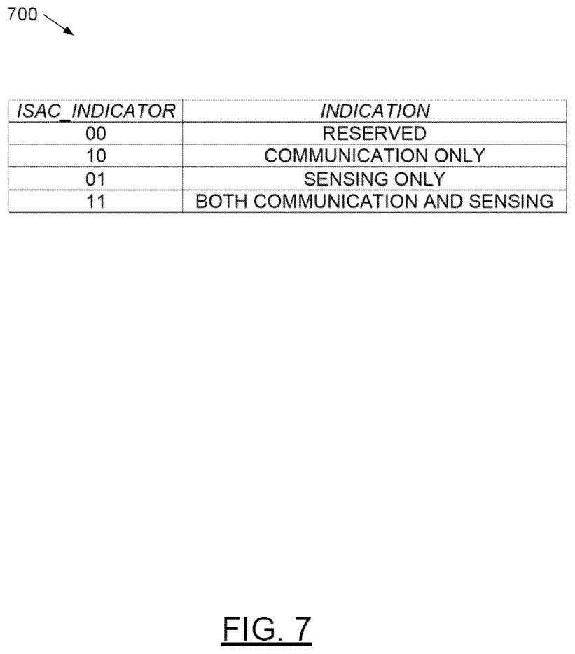

In some aspects of the present application, the value of the ISAC_indicator may be defined to take on one of four values. In such a case, the ISAC_indicator may be implemented as a two-bit indicator that specifies that a given three-dimensional resource block is configured for communication-only (ISAC_indicator=10), specifies that a given three-dimensional resource block is configured for sensing-only (ISAC_indicator=01) or specifies that the given three-dimensional resource block is configured for JSAC (ISAC_indicator=11). As illustrated in a table 700 in FIG. 7, one combination of bits (ISAC_indicator=00) is not used (i.e., “00” is defined as reserved). Notably, any one of the bit combinations may be defined as reserved, with each one of the other three being used to specify a corresponding one of the three types of signal configuration. In some other aspects of the present application, the value of the ISAC_indicator may be defined to take on one of two values. In such a case, the ISAC_indicator may be implemented as a one-bit indicator and may be used to distinguish between two types of signal configuration.

Aspects of the present application relate to defining three-dimensional resource blocks (3DRBs). An i^{th} 3DRB may be defined using a tuple 3DRBᵢ=(SDEᵢ, tᵢ, BWPᵢ), wherein SDEᵢ denotes an i^{th} spatial domain element in the space domain, tᵢ denotes an i^{th} time domain element (e.g., a symbol block) in the time domain and BWPᵢ denotes an i^{th} frequency domain element (e.g., bandwidth part/carrier) in the frequency domain. As discussed hereinbefore, each 3DRB may be configured for communication-only, for sensing only, for JSAC or for neither communication-only, nor sensing-only, nor JSAC.

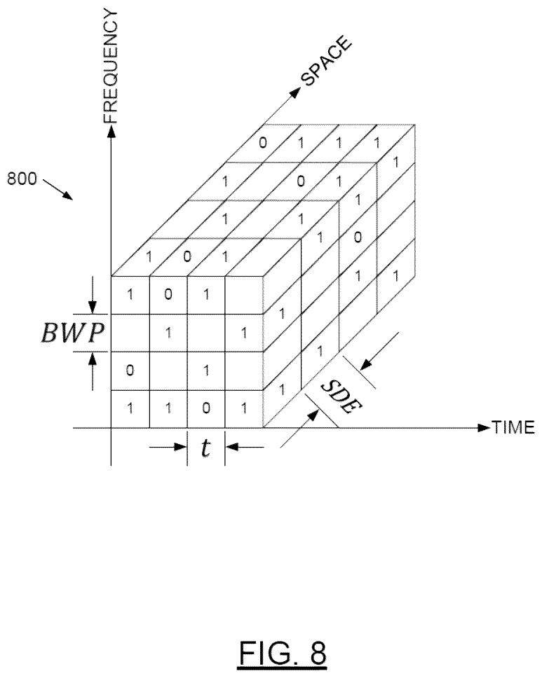

FIG. 8 illustrates a three-dimensional region 800 defined by a time axis, a frequency axis and a space axis. Within the three-dimensional region 800 are individual 3DRBs configured for communication only (ISAC_indicator=0), for joint communication and sensing (ISAC_indicator=1) or neither for communication nor for sensing (no ISAC_indicator shown).

The collection of individual 3DRBs illustrated in FIG. 8 may be considered to form a resource set, RS, which may be defined as a union of a quantity, M, of 3DRBs, RS={3DRBᵢ, i=1, . . . , M}. A specific RS may be assigned to a specific node (a TRP 170 and/or a UE 110) for sensing and/or communication signal transmission/reception.

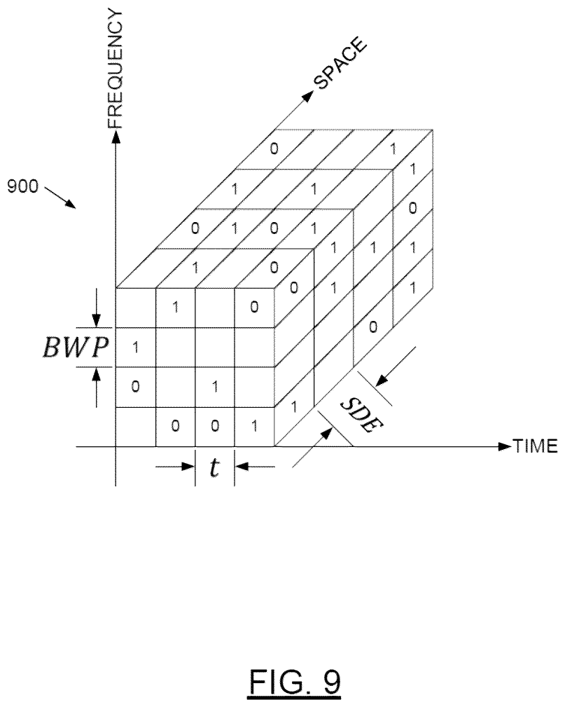

The RS of FIG. 8 may be considered an example of an RS assigned to a first node. In contrast, an RS illustrated in FIG. 9 in a region 900 may be considered an example of an RS assigned to a second node.

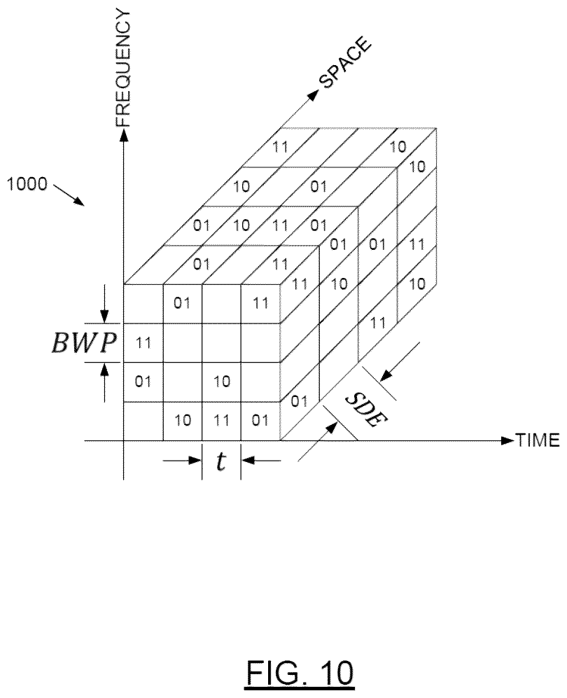

FIG. 10 illustrates a three-dimensional region 1000 defined by a time axis, a frequency axis and a space axis. Within the three-dimensional region 1000 are individual 3DRBs configured for communication-only (ISAC_indicator=01), for sensing-only (ISAC_indicator=01), for joint communication and sensing (ISAC_indicator=11) or neither for communication nor for sensing (no ISAC_indicator shown).

An RS may also be referenced as a “3D hopping pattern.” In each 3D hopping pattern, spatial domain patterns may be considered to cover an entire spatial region of interest. In some embodiments, a spatial domain element is a reference to an analog beamforming index for JSAC. In a particular approach, the 3D hopping pattern can only be defined/configured for communication configuration of JSAC. This particular approach may be taken to obtain a maximum time/frequency spanning over the spatial region of interest while managing inter-node interference. In some aspects of the present application, a given node can be configured with a pool containing multiple RSs. The multiple RSs can be used simultaneously (multi-layer sensing) or the given node may select one RS out of the pool. The selecting may be accomplished either randomly or according to a pre-configured mapping function.

A 3D hopping pattern may be generated by a module configured for the task of generating 3D hopping patterns.

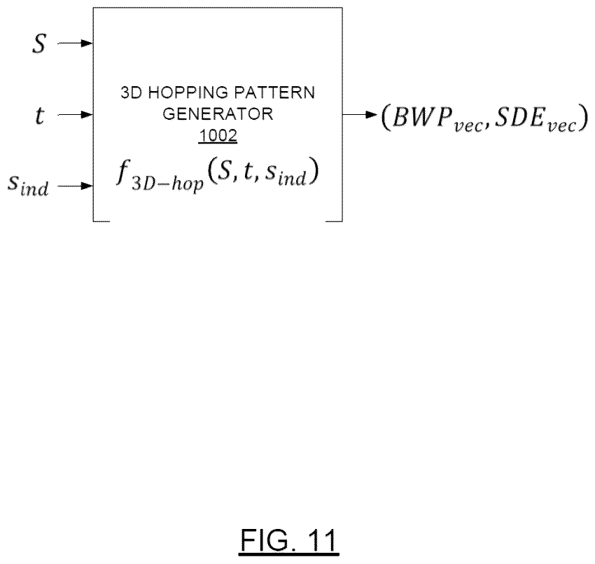

For example, FIG. 11 illustrates a 3D hopping pattern generator 1102. The 3D hopping pattern generator 1102 of FIG. 11 is illustrated as receiving, as input, an indication, S, of a spatial region of interest, an index, t, to a particular time and an identifier, s_{ind}, of a particular sensing node. According to aspects of the present application, the 3D hopping pattern generator 1102 of FIG. 11 is configured to implement a function, f_{3D-hop} (S, t, s_{ind}), to produce a pair of vectors, (BWP_{vec}, SDE_{vec}), including a bandwidth part vector, BWP_{vec}, and a spatial domain element vector, SDE_{vec}, on the basis of an indication, S, of a spatial region of interest, an index, t, to a particular time and an identifier, s_{ind}, of a particular sensing node.

As discussed hereinbefore and illustrated, for example, in the resource set of FIG. 8, communication and sensing may coexist within a JSAC 3DRB. Notably, however, such coexistence need not be a long-term situation. Indeed, the resource sets illustrated in FIGS. 8, 9 and 10 may be considered to be representative of a coexistence mode that may be turned on and off. A resource set representative of the coexistence mode being turned off (not shown) does not include any JSAC 3DRBs.

RRC signaling may be used to turn on or turn off the coexistence mode. Multi-cast signaling may be used to turn on or turn off the coexistence mode. Broadcast signaling may be used to turn on or turn off the coexistence mode.

For those times when the coexistence mode is turned on, there is a semi-static configuration case and a dynamic configuration case.

The semi-static configuration case mainly applies to common sensing. In the semi-static configuration case there is no need to introduce an additional indicator to distinguish between use of a MIMO layer, a polarization or a beam for the spatial domain element for sensing or communication or both. In the semi-static configuration case, an indication is carried by RRC signaling or broadcast signaling. The indication may be implemented on the basis of a pre-established association between a configuration (communication-only, sensing-only or JSAC) and a reference signal pattern. The particular reference signal pattern used may convey, to the receiver, which of a MIMO layer, a polarization or a beam is to be used for the spatial domain element. For example, a certain reference signal pattern may be linked with a JSAC configuration. Alternatively, a 3D hopping pattern indication, for long-term configuration, may be provided, to a receiver, via RRC signaling. Further alternatively, a hybrid approach may be used wherein both a reference signal pattern and 3D hopping pattern indication are used.

The dynamic configuration case mainly applies to dedicated sensing, in which a certain region of interest may be sensed for more detailed information. A configuration indication (communication-only, sensing-only or JSAC) may be carried in DCI. Certain parameters (e.g., waveform, waveform parameter, of which numerology is an example) may be predefined for each configuration among a plurality of configurations that are known by terminals. Information defining the plurality of configurations may be distributed to terminals via, for example, standard definition signaling, broadcast signaling or RRC signaling.

In the dynamic configuration case, a one-bit indication of ISAC_Indicator might be used, wherein ISAC_Indicator=1 indicates a JSAC configuration and ISAC_Indicator=0 indicates a communication-only configuration. In some aspects of the present application, a two-bit ISAC_Indicator may be used to incorporate the sensing-only configuration as well (see table 700 of FIG. 7).

In some aspects of the present application, DCI (or, at least, the first step of DCI) may be transmitted with a communication-only configuration and the data transmission can be switched between different configurations.

Without regard to the type of signal transmitted, it follows that the node that receives the signal may transmit feedback. The feedback may be transmitted over a feedback channel.

When the transmitted signal is of the communication-only type, it follows that the node that receives the communication-only signal may process the signal data and transmit communication-related feedback. That is, the node that receives the communication-only signal may transmit feedback associated with communication between the T-TRP 170 and the UE 110. The feedback associated with communication between the T-TRP 170 and the UE 110 may include CSI feedback (e.g., channel quality indicator, pre-coding matrix indicator, rank indicator) and ACK/NACK feedback. The feedback associated with communication between the T-TRP 170 and the UE 110 may include the one-bit indicator, ISAC_Indicator=0 or the two-bit indicator ISAC_Indicator=10, indicating that the feedback type corresponds to a communication-only signal.

When the transmitted signal is of the sensing-only type, it follows that the node that receives the sensing-only signal may process the signal to perform sensing measurements and transmit sensing-related feedback. The feedback may include an indication of sensing observations. The feedback may include the two-bit indicator ISAC_Indicator=01, indicating that the feedback type corresponds to a sensing-only signal.

When the transmitted signal is of the JSAC type, it follows that the node that receives the JSAC signal may process the signal data to decode data, perform sensing measurements and transmit feedback. The feedback may include sensing observations in addition to communication-related feedback. The feedback may include the one-bit indicator ISAC_Indicator=1 or the two-bit indicator ISAC_Indicator=11, indicating that the feedback type corresponds to a JSAC signal.

In some aspects of the present application, the feedback may not include the binary indicator ISAC_Indicator. That is, the feedback type may not be explicitly signaled. Instead, the feedback type can be configured through RRC signaling. In some aspects of the present application, the feedback type may be implicitly signaled through an association between feedback type and a spatial domain element (e.g., a MIMO layer, a polarization, a beam). The association between the feedback type and a spatial domain element may be established by transmitting a spatial domain element indicator in the feedback. The association between the feedback type and a spatial domain element may be established by transmitting a reference signal in the feedback channel.

To achieve efficiency when implementing a sensing-only approach, there is a balance to be struck.

The transmission of many spatially-narrow beams may be shown to be associated with accurate sensing. Narrow beams are achieved using beamforming and it is known that beamforming gain is greater the narrower the beam. Accordingly, transmission of narrow beams leads to relatively strong return signals.

The transmission of beams that cover a wide frequency bandwidth leads to good range resolution. Transmission of beams with longer scanning duration leads to relatively better estimates for Doppler shift and correlation.

Aspects of the present application relate to use of various analog beamforming schemes, digital beamforming schemes and hybrid analog-digital beamforming schemes. In the hybrid schemes, analog beamforming may be used to generate wide beams and digital beamforming may be used to generate narrow beams. In some other embodiments, digital beam forming and/or analog beamforming can be used to create the combination of wide and narrow beams

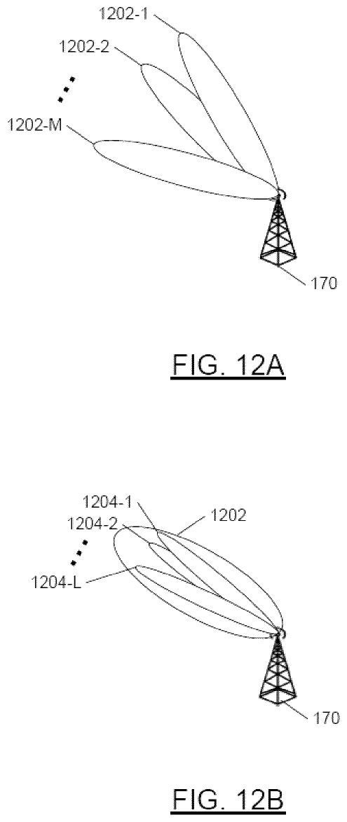

FIG. 12A illustrates a T-TRP 170 and a plurality of coarse (i.e., wide) radiation patterns corresponding to analog beamforming. The radiation patterns are labelled with reference numbers 1202-1, 1202-2, . . . , 1202-M. The suffix for each radiation pattern reference number has been discussed, in the context of FIG. 6, as an analog beamforming index.

FIG. 12B illustrates a T-TRP 170 and a plurality of narrow radiation patterns. The radiation patterns are labelled with reference numbers 1204-1, 1204-2, . . . , 1204-L. The narrow radiation patterns 604 are illustrated within a single generic wide radiation pattern 1202. The suffix for each narrow radiation pattern reference number has been discussed, in the context of FIG. 6, as a digital beamforming index. However, in an alternative context, wherein wide beams are generated using digital beamforming and narrow beams are generated using analog beamforming, the suffix for each narrow radiation pattern reference number may be an analog beamforming index.

Coarse beams (wide radiation patterns 1202) are known to be good for common sensing. Fine beams (narrow radiation patterns 1204) are known to be good for dedicated sensing. Fine beams 1204 are also known to be useful when defining beam-specific fine beamforming patterns over a grid of resource blocks organized by frequency (e.g., a BWP index) and time (symbol index).

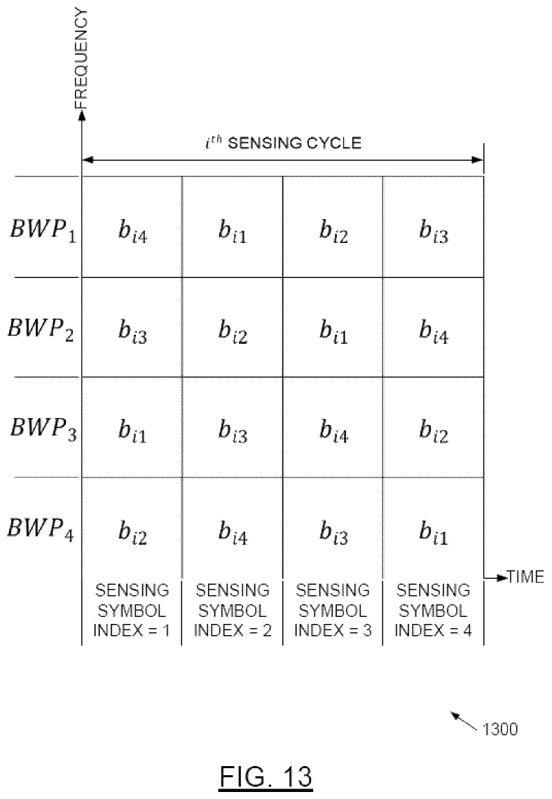

FIG. 13 illustrates a beam-time-frequency pattern 1300 associated with an i^{th} sensing cycle. The beam-time-frequency pattern 1300 is organized by a BWP index on a vertical frequency axis and a symbol index on a horizontal time axis. According to the beam-time-frequency pattern 1300, four narrow beams 1204, {bᵢ₁, bᵢ₂, bᵢ₃, bᵢ₄}, associated with a single coarse beam 1202 are transmitted based in a pre-specified hopping pattern. Notably, there is no change of the analog beamforming (the single coarse beam 1202) over each sensing cycle.

It should be clear that the beam-time-frequency pattern 1300 can be made node-specific to, thereby, obviate interference between distinct node transmitting sensing signals.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
establishing an association between a first resource block and a first type of signal, the first resource block defined using a first spatial domain element;
establishing an association between a second resource block and a second type of signal, the second resource block defined using a second spatial domain element;
transmitting the first type of signal in the first resource block; and
transmitting the second type of signal in the second resource block.

2. The method of claim 1, wherein the first type of signal comprises a communication-only signal, and the second type of signal comprises a joint sensing and communication signal or a sensing-only signal.

3. The method of claim 1, wherein the first spatial domain element comprises at least one of a beam, a multiple input multiple (MIMO) output layer, or a polarization.

4. The method of claim 1, further comprising associating the first spatial domain element of the first resource block with a first spatial domain index, among a plurality of spatial domain indices.

5. The method of claim 1, further comprising:
defining a reference signal pattern; and
associating the reference signal pattern with the first type of signal; and
wherein the transmitting the first type of signal includes transmitting the reference signal pattern.

6. The method of claim 1, further comprising:
associating a value of an indicator with the first type of signal; and
transmitting, to a terminal, an association of the value of the indicator with the first spatial domain element.

7. A method comprising:
obtaining an association between a first resource block and a first type of signal, the first resource block defined using a first spatial domain element;
obtaining an association between a second resource block and a second type of signal, the second resource block defined using a second spatial domain element;
receiving the first type of signal in the first resource block; and
receiving the second type of signal in the second resource block.

8. The method of claim 7, wherein the first type of signal comprises a communication-only signal, and the second type of signal comprises a joint sensing and communication signal or a sensing-only signal.

9. The method of claim 7, wherein the first spatial domain element comprises at least one of a beam, a multiple input multiple (MIMO) output layer, or a polarization.

10. The method of claim 7, further comprising associating the first spatial domain element of the first resource block with a first spatial domain index, among a plurality of spatial domain indices.

11. An apparatus comprising:
at least one processor configured, by executing instructions, to:
establish an association between a first resource block and a first type of signal, the first resource block defined using a first spatial domain element; and
establish an association between a second resource block and a second type of signal, the second resource block defined using a second spatial domain element; and
an interface coupled to the processor and configured by the processor to:
transmit the first type of signal in the first resource block; and
transmit the second type of signal in the second resource block.

12. The apparatus of claim 11, wherein the first type of signal comprises a communication-only signal, and the second type of signal comprises a joint sensing and communication signal or a sensing-only signal.

13. The apparatus of claim 11, wherein the first spatial domain element comprises at least one of a beam, a multiple input multiple (MIMO) output layer, or a polarization.

14. The apparatus of claim 11, wherein the processor is further configured, by executing instructions, to associate the first spatial domain element of the first resource block with a first spatial domain index, among a plurality of spatial domain indices.

15. The apparatus of claim 11, wherein the processor is further configured, by executing instructions, to define a reference signal pattern and associate the reference signal pattern with the first type of signal, and wherein the transmitting the first type of signal includes transmitting the reference signal pattern.

16. The apparatus of claim 11, wherein:
the processor is further configured, by executing instructions, to associate a value of an indicator with the first type of signal; and
the interface is further configured by the processor to transmit, to a terminal, an association of the value of the indicator with the first spatial domain element.

17. An apparatus comprising:
at least one processor configured, by executing instructions, to cause the apparatus to:
obtain an association between a first resource block and a first type of signal, the first resource block defined using a first spatial domain element; and
obtain an association between a second resource block and a second type of signal, the second resource block defined using a second spatial domain element; and
an interface coupled to the processor and configured by the processor to:
receive the first type of signal in the first resource block; and
receive the second type of signal in the second resource block.

18. The apparatus of claim 17, wherein the first type of signal comprises a communication-only signal, and the second type of signal comprises a joint sensing and communication signal or a sensing-only signal.

19. The apparatus of claim 17, wherein the first spatial domain element comprises at least one of a beam, a multiple input multiple (MIMO) output layer, or a polarization.

20. The apparatus of claim 17, wherein the processor is further configured to associate the first spatial domain element of the first resource block with a first spatial domain index, among a plurality of spatial domain indices.
